(19) United States
(12) Patent Application Publication
(10) Pub. No.: US 2017/0084982 A1
(43) Pub. Date: Mar. 23, 2017

(54) NEAR FIELD COMMUNICATION MODULE

(71) Applicant: 3M INNOVATIVE PROPERTIES COMPANY, St. Paul, MN (US)

(72) Inventors: Ya-Peng Fang, Shanghai (CN); Wei Li, Jiangsu Province (CN); Yang Lin, Shanghai (CN)

(21) Appl. No.: 15/310,477

(22) PCT Filed: May 13, 2015
(86) PCT No.: PCT/US2015/030590

§ 371 Date: Nov. 11, 2016

(30) Foreign Application Priority Data
May 14, 2014 (CN) 201410204146.8

(51) Int. Cl. H01Q 1/22; H01Q 7/00; H04B 5/00

(52) U.S. Cl. CPC H01Q 1/2291; H04B 5/0081; H04B 5/0056; H01Q 7/00

(57) ABSTRACT

The invention provides a near field communication module comprising: a magnetic substrate having opposing first and second surfaces and first and second through holes extending from the first surface to the second surface; and an antenna comprising: an annular coil having first and second ends, first and second feeding points, and first and second connecting lines for connecting the first and second ends of the annular coil to the first and second feeding points, respectively, wherein the antenna is configured such that the annular coil is provided on the first surface of the magnetic substrate, the first and second feeding points are provided on the second surface of the magnetic substrate, and the first and second connecting lines extend through the first and second through holes, respectively. The near field communication module has a greatly simplified structure and markedly reduced

### TECHNICAL FIELD

The invention relates to a near field communication module.

### BACKGROUND

A near field communication system is a near-distance (generally in the range of 20 to 30 cm) communication system based on a frequency of 13.56 MHz. It exhibits this unique advantage in various applications and in particular the application of mobile phone payment. The label or reader/writer in the near field communication system is provided with an antenna which can transmit the signal by the magnetic field coupling effect of the emitting antenna and receiving antenna at a frequency of 13.56 MHz. The antenna plays a very important role in the near field communication technology and the intensity of magnetic flux flowing through the antenna is an important factor which directly affects the quality of the signal transmission. However, when the antenna is close to a metallic surface such as a surface of a battery of a mobile phone, the magnetic field emitted by the antenna will result in eddy current loss at the metallic surface, which reduces the magnetic flux and causes a corresponding reduction of the quality factor of the antenna.

In a conventional near field communication module, an antenna for near field communication is generally etched or electroplated on a polyimide substrate and the polyimide substrate with the etched or electroplated antenna is then adhered on a ferrite substrate. Therefore, the conventional near field communication module is generally provided with a protection film, an antenna, a polyimide layer, an adhesive layer, a ferrite layer and a PET/adhesive layer in this order, wherein the annular coil and feeding points of the antenna are provided on two surfaces of the polyimide layer, respectively. However, such a module structure does not facilitate the reduction of the thickness of the entire module and the polyimide substrate generally does not have sufficient strength to support the feeding points of the antenna. Also, as hand-handled devices are further miniaturized and become even thinner, there is a need for even further reduction in the thickness of the near field communication module.

Therefore, there is a need to develop a near field communication module having a desirable structure to satisfy the requirements of reduced thickness and improved mechanical properties.

### SUMMARY

In order to solve the problem of the prior art, an object of the invention is to provide a near field communication module having a greatly simplified structure and markedly reduced total thickness and significantly improved mechanical properties, including rigidity.

To this end, the invention provides the following technical solutions.

In a first embodiment, a near field communication module includes a magnetic substrate having opposing first and second surfaces and first and second through holes extending from the first surface to the second surface; and an antenna comprising an annular coil having first and second ends, first and second feeding points, and first and second connecting lines for connecting the first and second ends of the annular coil to the first and second feeding points, respectively, wherein the antenna is configured such that the annular coil is provided on the first surface of the magnetic substrate, the first and second feeding points are provided on the second surface of the magnetic substrate, and the first and second connecting lines extend through the first and second through holes, respectively.

In a second embodiment, the near field communication module includes the first embodiment, wherein the magnetic substrate comprises a ferrite substrate or a magnetic composite film substrate.

In a third embodiment, the near field communication module includes any one of the first and second embodiments, further comprising first and second adhesive layers, wherein the first adhesive layer is disposed between the first surface of the magnetic substrate and the annular coil, and the second adhesive layer is disposed between the second surface of the magnetic substrate and the first and second feeding points.

In a fourth embodiment, the near field communication module includes any one of the first through third embodiments, wherein the annular coil and the first and second feeding points have a thickness in the range of 2 to 60 μm, respectively.

In a fifth embodiment, the near field communication module includes anyone of the proceeding embodiments, wherein the magnetic substrate has a thickness in the range of 10 to 500 μm. In a sixth embodiment, the near field communication module includes the third embodiment, wherein at least one of the first adhesive layer and the second adhesive layer has a thickness in the range of 1 to 30 μm.

In a seventh embodiment, the near field communication module includes any one of the third and sixth embodiments, wherein the near field communication module further comprises a protection film having an adhesive layer, wherein the protection film is located between the magnetic substrate and the first adhesive layer or between the magnetic substrate and the second adhesive layer, and the adhesive layer of the protection film is adjacent to the magnetic substrate.

In an eighth embodiment, the near field communication module includes the seventh embodiment, wherein the protection film having the adhesive layer has a thickness in the range of 1 to 30 μm.

In a ninth embodiment, the near field communication module includes any one of the seventh and eighth embodiments, wherein the protection film comprises a polymer film.

In a tenth embodiment, the near field communication module includes the ninth embodiment, wherein the polymer film comprises at least one of a polyethylene terephthalate film, a polyurethane film, a polyvinyl chloride film and a polypropylene film.

The near field communication module according to the invention has a greatly simplified structure and markedly reduced total thickness and significantly improved mechanical properties, for example rigidity.

### BRIEF DESCRIPTION OF THE DRAWINGS

FIG. 1 shows a schematic top view of the annular coil side of a first embodiment of a near field communication module, in accordance with the present disclosure.

FIG. 2 shows a schematic top view of the feeding points side of the near field communication module shown in FIG. 1, in accordance with the present disclosure.

FIG. 3 is an enlarged, schematic partial cross sectional view of the near field communication module shown in FIG. 1, in accordance with the present disclosure.

FIG. 4 shows a schematic top view of the annular coil side of a second embodiment of a near field communication module, in accordance with the present disclosure.

FIG. 5 shows a schematic top view of the feeding points side of the near field communication module shown in FIG. 4, in accordance with some embodiments of the present disclosure.

FIG. 6 is an enlarged, schematic partial cross sectional view of a near field communication module in accordance with some embodiments of the present disclosure.

FIG. 7 is an enlarged, schematic partial cross sectional view of a near field communication module in accordance with some embodiments of the present disclosure.

### DETAILED DESCRIPTION

The near field communication module of the invention comprises: a magnetic substrate having opposing first and second surfaces and first and second through holes extending from the first surface to the second surface; and an antenna comprising: an annular coil having first and second ends, first and second feeding points, and first and second connecting lines for connecting the first and second ends of the annular coil to the first and second feeding points, respectively, wherein the antenna is configured such that the annular coil is provided on the first surface of the magnetic substrate, the first and second feeding points are provided on the second surface of the magnetic substrate, and the first and second connecting lines extend through the first and second through holes, respectively.

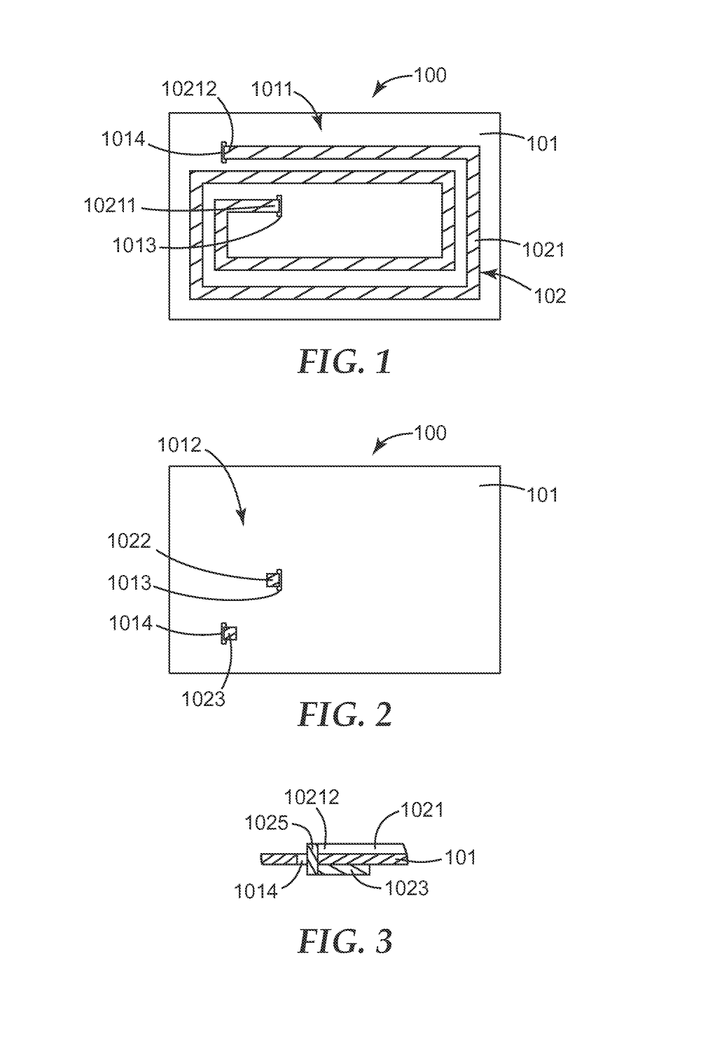

FIG. 1 shows the first surface of a first embodiment of near field communication module according to the present disclosure, and FIG. 2 shows the second surface of the near field communication module shown in FIG. 1. As shown in FIGS. 1 and 2, a near field communication module 100 comprises: a magnetic substrate 101 having opposing first and second surfaces 1011, 1012 and first and second through holes 1013, 1014 extending from the first surface 1011 to the second surface 1012; and an antenna 102 comprising: an annular coil 1021 having first and second ends 10211, 10212, first and second feeding points 1022, 1023, and first and second connecting lines 1024, 1025 (not shown in FIGS. 1 and 2) for connecting the first and second ends 10211, 10212 of the annular coil 1021 to the first and second feeding points 1022, 1023, respectively, wherein the antenna 102 is configured such that the annular coil 1021 is provided on the first surface 1011 of the magnetic substrate 101, the first and second feeding points 1022, 1023 are provided on the second surface 1012 of the magnetic substrate 101, and the first and second connecting lines 1024, 1025 (not shown in FIGS. 1 and 2, see FIG. 3) extend through the first and second through holes 1013, 1014, respectively.

For the sake of clarity, FIG. 3 shows an enlarged, partial cross sectional view of the near field communication module shown in FIG. 1 in the region of second through hole 1014. As shown in FIG. 3, the second connecting line 1025 extends through the second through hole 1014, connecting the second end 10212 of the annular coil 1021 to the second feeding point 1023. Although not shown in FIG. 3, in a similar configuration, first connecting line 1024 extends through the first through hole 1013, connecting the first end 10211 of the annular coil 1021 to the first feeding point 1022.

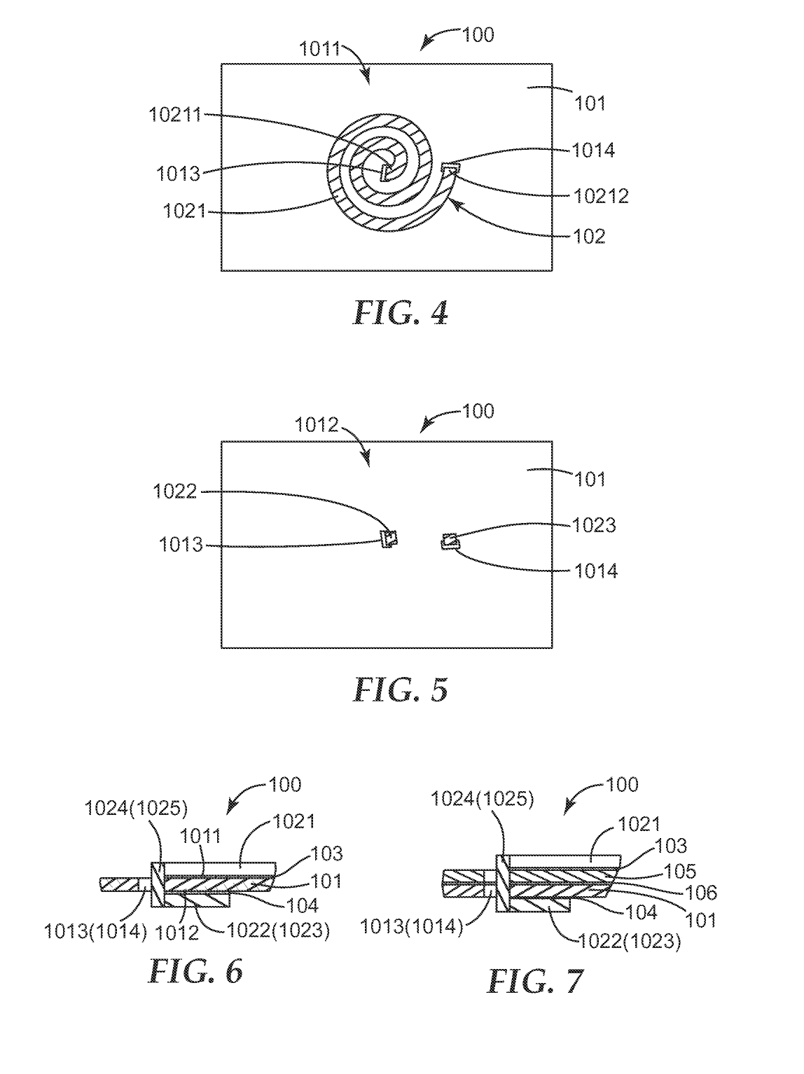

In the near field communication module according to the invention, the shape of the annular coil is not limited as long as it is annular. FIG. 4 shows the first surface of a second embodiment of near field communication module according to the present disclosure, and FIG. 5 shows the second surface of the near field communication module shown in FIG. 4. The descriptions of the components of FIGS. 4 and 5 are identical to those of FIGS. 1 and 2, subsequently the same element numbers are used for identical components.

The magnetic substrate which may be used in the invention includes a ferrite substrate or a magnetic composite film substrate. The ferrite substrate may be a Ni—Cu—Zn sintered ferrite which contains Fe₃O₄ as the main component and Ni, Cu and Zn as the additive elements. Ferrite substrates are commercially available, for example, under the trade designation “AB5007RF” available from 3M Company, St. Paul, Minn.; “FSF SERIES” of sintered ferrite sheets, including FSF131, FSF151, FSF201 and FSF501 available from Maruwa Company, LTD., Owariasahi-City, Aichi, Japan: and “FLX-950-X060” of Toda Company, Hiroshima, Japan.

The magnetic composite film substrate may be a film made of a composite material of magnetic particles such as Fe—Si—Al, Fe—Si—Cr, Fe—Co, or Fe—Ni alloy particles and a polymer material. In some embodiments, the polymer material is a flexible thermoplastic, thermoplastic elastomer, or elastomer, i.e. a rubber, such as butadiene-acrylonitrile rubber. Magnetic composite film substrates are commercially available, for example, under the trade designation “RFIC” composite absorber, including RFIC15, available from 3M Company. The magnetic substrate may have a thickness in the range of 10 to 500 μm and preferably 10 to 200 μm. When the magnetic composite film substrate is used, the magnetic composite film substrate may have a thickness in the range of 100 to 500 μm.

The antenna may be made of a conductive metal, e.g. Cu, silver gold, aluminum, or other material such as Cu cladded with Au, Cu cladded with Ag, Cu cladded with Ni or Cu cladded with Ni—Au, or Ni—Ag alloy. Various components of the antenna may have the same thickness. For example, the annular coil and the first and second feeding points may have a thickness in the range of 2 to 60 μm, respectively.

According to a preferable embodiment of the invention, the near field communication module may further comprise first and second adhesive layers. FIG. 6 is an enlarged, partial cross sectional view of the near field communication module in accordance with some embodiments of the present disclosure. As shown in FIG. 6, the near field communication module 100 includes first and second adhesive layers 103 and 104, and the first adhesive layer 103 is disposed between the first surface 1011 of the magnetic substrate 101 and the annular coil 1021, and the second adhesive layer 104 is disposed between the second surface 1012 of the magnetic substrate 101 and the first feeding point 1022. FIG. 6 also shows first connecting line 1024 and first through hole 1013. Note that the configuration shown in FIG. 6 would be nearly identical for that of the second feeding point 1023, second through hole 1014 and second connecting line 1025. Thus, these elements are indicated in parenthesis in FIG. 6. At least one of the first adhesive layer and the second adhesive layer may have a thickness in the range of 1 to 30 μm. The materials of the first and second adhesive layers are conventional ones, for example, acrylic adhesive. Pressure sensitive adhesives or cure in place adhesives may be used.

According to another embodiment of the invention, the near field communication module may further comprise a protection film having an adhesive layer, and the protection film may be located between the magnetic substrate and the first adhesive layer or between the magnetic substrate and the second adhesive layer, and the adhesive layer of the protection film is adjacent to the magnetic substrate. FIG. 7 is an enlarged, partial cross sectional view of the near field communication module according to this embodiment of the present disclosure. As shown in FIG. 7, the near field communication module 100 further comprises a protection film 105 having an adhesive layer 106, and the protection film 105 is located between the magnetic substrate 101 and the first adhesive layer 103. The adhesive layer 106 of the protection film 105 is adjacent to the magnetic substrate 101. FIG. 7 also shows annular coil 1021 and second adhesive layer 104. As the general configuration shown in FIG. 7 would be the same for regions around both the first and second through holes, FIG. 7 also shows first or second through hole 1013 (1014); first or second connecting lines 1024 (1025); and first or second feeding point 1022 (1023).

The protection film may comprise a polymer film. The polymer film may comprise at least one of a polyethylene terephthalate (PET) film, a polyurethane (PU) film, a polyvinyl chloride (PVC) film and a polypropylene (PP) film. The material of the adhesive layer of the protection film is conventional one, for example, acrylic adhesive. The protection film having the adhesive layer may have a thickness in the range of 1 to 30 μm.

The present invention is more particularly described in the following examples that are intended as illustrations only, since numerous modifications and variations within the scope of the present invention will be apparent to those skilled in the art.

### EXAMPLES

### Materials

| Product Name | Description |
|---|---|
| AB5007RF | A double-layer film constituted by a 60 μm-thick Ni—Cu—Zn |
| | sintered ferrite layer and a 10 μm-thick black polyethylene |
| | terephthalate film with an acrylic adhesive, available under the |
| | trade designation “AB5007RF”, from 3M Company, St. Paul, |
| | Minnesota. |
| Copper Foil | 12 μm -thick copper foil available from Circuit Foil Luxenburg |
| | Electrolytic Copper, Wiltz, Luxembourg. |
| 87622BP Tape | A 48 micron thick PET film with a single coated pressure sensitive |
| | adhesive (PSA) tape, available under the trade designation |
| | “87622BP” from 3M Company. |
| 82600 | 5 μm-thick double coated acrylic pressure sensitive (PSA) tape, |
| | available under the trade designation “3M Electronic Double Sided |
| | Tape 82600”, from 3M Company. |
| 82601 | 10 μm-thick double coated acrylic pressure sensitive adhesive |
| | (PSA) tape, available under the trade designation “3M Electronic |
| | Double Sided Tape 82601”, from 3M Company. |
| RFIC Composite | A 300 μm-thick Fe—Si—Cr composite absorber, available under the |
| Absorber | trade designation “RFIC Composite Absorber”, from 3M |
| | Company. |
| 6052XL | 12.5 μm-thick polyimide film, available under the trade |
| | designation “6052XL”, from Tianjin Tianyuan Electric Material |
| | Co., Ltd., Tianjin City, China. |
| 7412B | 50 μm-thick polyimide film with 30 μm single coated acrylic |
| | pressure sensitive adhesive tape, available under the trade |
| | designation “3M Non-silicone Polyimide Film Tape 7412B”, from |
| | 3M Company. |

### Test Methods

### Electrical Resistance Test Method

The electrical resistance of the near field communication (NFC) antenna was measured between the two feeding points of the NFC antenna by using a Keithley 580 micro-ohmmeter available from Keithley Instruments Inc., Cleveland, Ohio.

### Rigidity Test Method

The rigidity of the NFC module was measured by Elmendorf Tearing tester available from THWING-ALBERT Instrument Co., Philadelphia, U.S.A. First, a sample was cut into 63 mm×80 mm piece, and put into the test fixture of the tear tester. A20 mm wide slot was cut in the middle of the sample, using a knife. The pendulum bob of the tester was placed down on the slot. A load was applied to the pendulum bob. The load of the pendulum bob required to tear the slot was then read and recorded as the rigidity, in grams, see Table 2.

### Near Field Communication Performance Test Method

The reading performance of the NFC module was measured by using Micropross contactless test station available from Micropross Inc., Lille, France and NXP PN544 as the chip. This test station was based on the EMV near field communication standard.

### Example 1

A near field communication (NFC) module was prepared as follows. AB5007RF ferrite sheet was used as the magnetic material. The relative permeability of this magnetic material was about 150 at the working frequency of the near field communication of 13.56 MHz. Two through holes were cut by a knife in the AB5007RF ferrite sheet. The through holes had a rectangular shape with a 1.5 mm length and a 0.5 mm width.

Copper Foil, 12 μm-thick, was used to make the NFC antenna. The bottom side of the Copper Foil was laminated to the adhesive layer of the 87622BP Tape (protective film), and the top side of the Copper Foil then laminated with an adhesive surface of 82600, forming a copper foil laminate structure.

The copper foil laminate structure was subjected to a kiss-cut process to form a NFC antenna. A blade having a depth of 25 μm was used in the kiss-cut process. In the kiss-cut process, the 82600 PSA tape was cut first, then the copper foil was cut, without cutting through the 87622BP (protective film). After the kiss-cut process, the 87622BP PSA tape and the attached Copper Foil was peeled away from the cut laminate. In the laminate, the formed NFC antenna had an annular coil having two ends, two feeding points, and two connecting lines for connecting the two ends of the annular coil to the two feeding points, respectively. The annular coil had 4 turns of rectangular line with a 1-mm line width, and 0.5-mm line spacing. The size or area of the annular coil was 35 mm×55 mm. The feeding points and the connecting lines had the same line width of 1 mm. Note that the annular coil design of the antenna coincided with the die design used in the kiss cut process.

The release liner was removed from the 82600 PSA tape of the NFC antenna, and the NFC antenna was adhered onto the PET film side of the die-cut AB5007RF ferrite. The feeding points of the NFC antenna were passed through the two through holes of the die-cut AB5007RF ferrite sheet and flipped over and adhered onto the other side of the ferrite sheet. The feeding points had a length of about 5 mm. A NFC module was obtained, Example 1. A piece of 82601 tape was laminated onto the feeding point side of the NFC module to adhere this module to an electronic device.

### Example 2

A near field communication (NFC) module was prepared as follows. A sheet of RFIC Composite Absorber was used as the magnetic material. The relative permeability of this magnetic material was about 45 at the working frequency of the near field communication of 13.56 MHz. Two through holes were cut by a knife in the RFIC Composite Absorber. The through holes had a rectangular shape with a 1.5 mm length and a 0.5 mm width.

A copper foil laminate structure and an NFC antenna was prepared as described in Example 1.

A release liner was released from the 82600 PSA tape in the laminate, and the annular coil of the NFC antenna was adhered onto a side of the die-cut RFIC Composite Absorber sheet. The feeding points of the NFC antenna were passed through the two through holes of the die-cut RFIC Composite Absorber sheet and flipped over and adhered onto the other side of the RFIC Composite Absorber sheet. The feeding points had a length of about 5 mm. A NFC module was obtained, Example 2. A piece of 82601 tape was laminated onto the feeding point side of the NFC module to adhere this module to an electronic device.

### Comparative Example A

A comparative near field communication (NFC) module was prepared as follows. First a NFC antenna was prepared. 6052XL polyimide film was laminated to a piece o Copper Foil via a 5 μm epoxy resin adhesive film A second piece of Copper Foil was laminated to the other side of the 6052XL polyimide filmt via a 5 μm epoxy resin adhesive film to form a laminate structure. A NFC antenna was made by etching the laminate with a 220 g/l solution of ammonium peroxydisulfate (NH₄)₂S₂O₈. Before the etching, the region of the copper foil used for forming an annular coil pattern of the NFC antenna and the region of the copper foil used for forming feeding points of the NFC antenna were protected by a piece of 7412B single coated tape. After the etching, the 7412B tape was removed, and the annular coil pattern and the feeding points which had been separately formed on the two sides of the polyimide film were then cleaned by washing with deionized water. The formed annular coil had 4 turns of rectangular line with a 1 mm line width, and a 0.5 mm line spacing. The size or area of the annular coil was 35 mm×55 mm. The feeding points have a line width of about 1 mm and a length of about 5 mm.

Two through holes were drilled in the polyimide film at the positions corresponding to two ends of the annular coil and the feeding points. The feeding points and the annular copper coil were then electrically connected via the two through holes in the polyimide film by electroplating. Copper sulfate (CuSO₄.5H₂O) and sulfuric acid were used as the electroplating solution. The voltage for plating copper was as low as 0.2 V for a cathode and the anode current density was 1.6 to 2.2 A dm⁻¹. After the electroplating, a NFC antenna comprising the annular coil, the two feeding points, and two connecting lines for connecting the two ends of the annular coil to the two feeding points was obtained.

Subsequently, a sheet of AB5007RF ferrite was used as the magnetic material for the NFC module. The annular coil of the NFC antenna provided with the polyimide film was laminated to the adhesive side of the AB5007RF ferrite sheet. A NFC module was obtained, Comparative Example A. A piece of 82601 tape was laminated onto the feeding points side of the NFC module to adhere this module to an electronic device.

### Comparative Example B

An NFC antenna was prepared as described in Comparative Example A.

Subsequently, a sheet of RFIC Composite Absorber was used as the magnetic material. The annular coil of the NFC antenna provided with the polyimide film was laminated to a side of RFIC Composite Absorber via a piece of 82601 tape. A NFC module was obtained, Comparative Example B. A piece of 82601 tape was laminated onto the feeding points side of the NFC module to adhere this module to an electronic device.

The electrical resistance, rigidity and near field communication performance of the near field communication (NFC) modules produced in the Examples 1 and 2 and Comparative Examples A and B were measured according to the test methods described above.

Table 1 summarizes the structure and the total thickness for the near field communication (NFC) modules of Examples 1 and 2 and Comparative Examples A and B.

TABLE 1

| Example 1 | | Comparative Example A | | Example 2 | |
|---|---|---|---|---|---|
| structure | Thickness | structure | thickness | structure | Thickness |
| (material) | (μm) | (material) | (μm) | (material) | (μm) |
| annular coil | 12 | protection film | 10 | annular coil | 12 |
| (Cu layer) | | (PET/acrylic | | (Cu layer) | |
| | | adhesive) | | | |
| first adhesive | 5 | ferrite layer | 60 | first adhesive | 5 |
| layer (acrylic | | (Ni—Cu—Zn | | layer (acrylic | |
| adhesive) | | sintered ferrite) | | adhesive) | |
| protection film | 10 | adhesive layer | 10 | magnetic | 300 |
| (PET/acrylic | | (acrylic adhesive) | | substrate | |
| adhesive) | | | | (Fe—Si—Cr | |
| | | | | composite | |
| | | | | absorber) | |
| magnetic | 60 | annular coil | 12 | second | 5 |
| substrate | | (Cu layer) | | adhesive | |
| (Ni—Cu—Zn | | | | layer (acrylic | |
| sintered ferrite) | | | | adhesive) | |
| second adhesive | 5 | adhesive film | 5 | first and | 12 |
| layer (acrylic | | (epoxy resin) | | second | |
| adhesive) | | | | feeding | |
| | | | | points (Cu | |
| | | | | layer) | |
| first and second | 12 | polyimide layer | 12.5 | PSA tape for | 10 |
| feeding points | | | | adhering the | |
| (Cu layer) | | | | module to an | |
| | | | | electronic | |
| | | | | device | |
| PSA tape for | 10 | adhesive film | 5 | | |
| adhering the | | (epoxy resin) | | | |
| module to an | | | | | |
| electronic | | | | | |
| device | | | | | |
| | | feeding points | 12 | | |
| | | (Cu layer) | | | |
| | | PSA tape for | 10 | | |
| | | adhering the | | | |
| | | module to an | | | |
| | | electronic device | | | |
| Total Thickness | 114 | | 136.5 | | 344 |
| (μm) | | | | | |

As shown in Table 1, the near field communication module of Example 1 has a greatly simplified structure and markedly reduced total thickness than that of Comparative Example A, and the near field communication module of the Example 2 has a greatly simplified structure and markedly reduced total thickness than that of the Comparative Example B. This simplification of structure and significant reduction in the total thickness are particularly important for the minimization and thickness reduction of an electronic device.

Table 2 summarizes the thickness and rigidity of the layer for supporting the feeding points in the near field communication (NFC) modules produced in Examples 1 and 2 and the comparative Examples A and B.

TABLE 2

| | | | Comparative | Comparative |
|---|---|---|---|---|
| | Example 1 | Example 2 | Example A | Example B |
| Layer for | Ferrite | Composite | Polyimide | Polyimide |
| supporting the | layer + | absorber | layer | layer |
| feeding points | PET film | layer | | |
| Thickness(μm) | 70 | 300 | 12.5 | 12.5 |
| Rigidity (g) | 173 | 117 | 26 | 26 |

As shown in Table 2, the near field communication module of Example 1 has a greater thickness and rigidity of the layer for supporting the feeding points than those of the Comparative Example A. Similarly, near field communication module of the Example 2 has a greater thickness and rigidity of the layer for supporting the feeding points than those of the Comparative Example B. This demonstrates that the near field communication modules of the Examples 1 and 2 have significantly improved mechanical properties compared to those of Comparative Examples A and B.

Table 3 summarizes the resistance and Q factor at 13.56 MHz of the near field communication (NFC) modules produced in Examples 1 and 2 and Comparative Examples A and B.

TABLE 3

| | | | Comparative | Comparative |
|---|---|---|---|---|
| | Example 1 | Example 2 | Example A | Example B |
| Resistance (Ohm) | 0.9 | 0.9 | 1.1 | 1.1 |
| Q factor at 13.56 | 35 | 34 | 35 | 33 |
| MHz | | | | |

As shown in Table 3, the resistance and Q factor at 13.56 MHz of the near field communication (NFC) modules produced in Examples 1 and 2 are similar to those of the Comparative Examples A and B.

Table 4 shows the reading performance of the near field communication module of Example 1, wherein the “Position of PICC” means the coordinate of the position of the near field communication module relative to a receiving antenna, the “Minimum Value required (mV)” means a voltage minimum value required for the near field communication module at the position of PICC and “Vpp, A (mV)” means a difference between the peak value and valley value of the voltage of the near field communication module at the position of PICC.

TABLE 4

| | | |
|---|---|---|
| Minimum | | |
| Value required | Position | Card Reader Mode |

| (mV) | of PICC | verdict | Vpp, A(mV) |
|---|---|---|---|
| 8.8 | (0, 0, 0) | PASS | 29.1 |
| 4.9 | (0, 1, 0) | PASS | 20.8 |
| | (0, 1, 3) | PASS | 29 |
| | (0, 1, 6) | PASS | 26.2 |
| | (0, 1, 9) | PASS | 20.2 |
| 7.2 | (1, 0, 0) | PASS | 16.5 |
| 4.1 | (1, 1, 0) | PASS | 11.9 |
| | (1, 1, 3) | PASS | 16.2 |
| | (1, 1, 6) | PASS | 15.1 |
| | (1, 1, 9) | PASS | 11.4 |
| 5.6 | (2, 0, 0) | PASS | 9 |
| 3.3 | (2, 1, 0) | PASS | 6.1 |
| | (2, 1, 3) | PASS | 8.6 |
| | (2, 1, 6) | PASS | 7.9 |
| | (2, 1, 9) | PASS | 5.9 |
| 4 | (3, 0, 0) | PASS | 4.3 |

As shown in Table 4, at the position of PICC of (0, 0, 0), the voltage value of the near field communication module of Example 1 reaches or exceeds 8.8 mV required at this position, so that a verdict of “PASS” for the near field communication module of Example 1 was made, and a verdict of “PASS” for the near field communication module of the Example 1 at the other positions of PICC was also made. Therefore, based on the results of Table 4, it can be concluded that the near field communication module according to Example 1 of the invention satisfied the EMV standard.

Similarly, the NFC modules of Example 2 as well as Comparative Examples A and B were also measured in terms of the reading performance and determined to “Pass” the EMV standard at all positions of PICC.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

1. A near field communication module comprising:
a magnetic substrate having opposing first and second surfaces and first and second through holes extending from the first surface to the second surface; and
an antenna comprising:
an annular coil having first and second ends,
first and second feeding points, and
first and second connecting lines for connecting the first and second ends of the annular coil to the first and second feeding points, respectively,
wherein the antenna is configured such that the annular coil is provided on the first surface of the magnetic substrate, the first and second feeding points are provided on the second surface of the magnetic substrate, and the first and second connecting lines extend through the first and second through holes, respectively.

2. The near field communication module according to claim 1, wherein the magnetic substrate comprises a ferrite substrate or a magnetic composite film substrate.

3. The near field communication module according to claim 1, further comprising first and second adhesive layers, wherein the first adhesive layer is disposed between the first surface of the magnetic substrate and the annular coil, and the second adhesive layer is disposed between the second surface of the magnetic substrate and the first and second feeding points.

4. The near field communication module according to claim 1, wherein the annular coil and the first and second feeding points have a thickness in the range of 2 to 60 μm, respectively.

5. The near field communication module according to claim 1, wherein the magnetic substrate has a thickness in the range of 10 to 500 μm.

6. The near field communication module according to claim 3, wherein at least one of the first adhesive layer and the second adhesive layer has a thickness in the range of 1 to 30 μm.

7. The near field communication module according to claim 3, wherein the near field communication module further comprises a protection film having an adhesive layer, wherein the protection film is located between the magnetic substrate and the first adhesive layer or between the magnetic substrate and the second adhesive layer, and the adhesive layer of the protection film is adjacent to the magnetic substrate.

8. The near field communication module according to claim 7, wherein the protection film having the adhesive layer has a thickness in the range of 1 to 30 μm.

9. The near field communication module according to claim 7, wherein the protection film comprises a polymer film.

10. The near field communication module according to claim 9, wherein the polymer film comprises at least one of a polyethylene terephthalate film, a polyurethane film, a polyvinyl chloride film and a polypropylene film.
